(19) United States
(12) Patent Application Publication
(10) Pub. No.: US 2024/0352884 A1
(43) Pub. Date: Oct. 24, 2024

(54) AFTERTREATMENT COMPONENT CARTRIDGE FOR AN AFTERTREATMENT SYSTEM

(71) Applicant: Cummins Emission Solutions Inc., Columbus, IN (US)

(72) Inventors: Bhabani S. Sahu, Angul (IN); Varjavan Khushroo Dastoor, Pune (IN); Pravin Shankarrao Sakunde, Pune (IN); Reshma Pattan, Guntur (IN)

(73) Assignee: Cummins Emission Solutions Inc., Columbus, IN (US)

(21) Appl. No.: 18/292,270

(22) PCT Filed: Jul. 29, 2021
(86) PCT No.: PCT/US2021/043753

§ 371 Date: Jan. 25, 2024

(51) Int. Cl. F01N 13/18; F16L 23/036; F16L 23/22

(52) U.S. Cl. CPC F01N 13/1888; F01N 13/1827; F16L 23/036; F16L 23/22

(57) ABSTRACT

An aftertreatment system includes an inlet conduit assembly, an aftertreatment component cartridge, and an outlet conduit assembly. The inlet conduit assembly receives an exhaust gas and includes an inlet coupling flange portion. The aftertreatment component cartridge is coupled to the inlet conduit assembly and receives the exhaust gas from the inlet conduit assembly. The aftertreatment component cartridge also includes an adaptor. The outlet conduit assembly is coupled to the aftertreatment component cartridge and receives the exhaust gas from the aftertreatment component cartridge. The outlet conduit assembly includes an outlet coupling flange portion. The inlet coupling flange portion, adaptor, and outlet coupling flange portion cooperate to suspend the aftertreatment component cartridge within the aftertreatment system.

### CROSS-REFERENCE TO RELATED PATENT APPLICATIONS

This application is a National Phase of PCT Application No. PCT/US2021/043753, filed Jul. 29, 2021. The contents of this application is incorporated herein by reference in its entirety.

### TECHNICAL FIELD

The present disclosure relates generally to an exhaust aftertreatment system for an internal combustion engine, and an aftertreatment component cartridge and an installation method and a replacement method thereof.

### BACKGROUND

For an internal combustion engine system, it may be desirable to replace or repurpose components of an aftertreatment system used to capture undesirable material and particulate from exhaust gas produced by a combustion of fuel. As a result, such components in aftertreatment systems may be designed to be removable.

One approach that may be implemented in an aftertreatment system is to support an aftertreatment system component used to capture undesirable material and particulate with wire mesh rope. However, existing designs with wire mesh rope can result in some undesirable material and particulate passing through the wire mesh rope, which reduces the effectiveness of the internal combustion engine system.

Other approaches include assembling the aftertreatment system using multiple joints or clamps at either end of a component. However, these approaches increase the amount of space needed for the aftertreatment system, leading to increased costs and less space for other systems. Further, because these approaches utilize multiple joints, there is an increased likelihood of exhaust gas escaping through the joints and causing increased temperatures in surrounding components.

### SUMMARY

In one embodiment, an aftertreatment system includes an inlet conduit assembly, an outlet conduit assembly, and an aftertreatment component cartridge. The inlet conduit assembly is upstream of the aftertreatment component cartridge and outlet conduit assembly and includes an inlet body comprising an inlet body wall portion and an inlet coupling flange portion. The outlet conduit assembly is downstream of the inlet conduit assembly and aftertreatment component cartridge and includes an outlet body comprising an outlet body wall portion and an outlet coupling flange portion. The aftertreatment component cartridge comprises an aftertreatment component housing, an adaptor, and an aftertreatment system component. An inlet portion of the aftertreatment component housing is inserted into the inlet body and an outlet portion of the aftertreatment component housing is inserted into the outlet body. The adaptor comprises a first flange portion coupled to the aftertreatment component housing and disposed between the inlet body wall portion and the aftertreatment component housing, a second flange portion coupled to the aftertreatment component housing and disposed between the outlet body wall portion and the aftertreatment component housing, and a coupler portion disposed between the first flange portion and the second flange portion. The coupler portion extends between the inlet coupling flange portion and the outlet coupling flange portion. The aftertreatment system component is positioned within the aftertreatment component housing. The adaptor cooperates with the inlet and outlet coupling portions such that the aftertreatment component cartridge may be suspended within the aftertreatment system with a single fastener (e.g., clamp, strap, band clamp, bolted joint, etc.) by fixing the aftertreatment component cartridge to the inlet body and outlet body, which reduces the number of joints and support structures needed and allows for faster and easier installation and replacement of the aftertreatment component cartridge.

In another embodiment, an aftertreatment system includes an inlet conduit assembly, an outlet conduit assembly, and an aftertreatment component cartridge. The inlet conduit assembly is upstream of the aftertreatment component cartridge and outlet conduit assembly and includes an inlet body comprising an inlet body wall portion and an inlet coupling flange portion. The outlet conduit assembly is downstream of the inlet conduit assembly and aftertreatment component cartridge and includes an outlet body comprising an outlet body wall portion and an outlet coupling flange portion. The aftertreatment component cartridge comprises an aftertreatment component housing, an adaptor, and an aftertreatment system component. An inlet portion of the aftertreatment component housing is inserted into the inlet body and an outlet portion of the aftertreatment component housing is inserted into the outlet body. The adaptor comprises a first coupling wall portion coupled to the aftertreatment component housing and disposed between the inlet coupling flange portion and the aftertreatment component housing, a second coupling wall portion coupled to the aftertreatment component housing and disposed between the outlet coupling flange portion and the aftertreatment component housing, and a coupler portion extending between the inlet coupling flange portion and the outlet coupling flange portion.

In yet another embodiment, an aftertreatment component cartridge for an aftertreatment system includes an aftertreatment component housing, an adaptor, and an aftertreatment system component. The first flange portion is coupled to the aftertreatment component housing. The first connecting wall portion is contiguous with the first flange portion. A portion of the first connecting wall portion extends along a first slope from the first flange portion. The first slope has a first angle along a reference plane bisecting the adaptor. The first coupling wall portion is contiguous with the first connecting wall portion. A portion of the first coupling wall portion extends along a second slope from the first connecting wall portion. The second slope has a second angle along the reference plane. The second angle is greater than the first angle. The second flange portion is coupled to the aftertreatment component housing. The second connecting wall portion is contiguous with the second flange portion. A portion of the second connecting wall portion extends along a third slope from the second flange portion. The third slope has a third angle along the reference plane. The second coupling wall portion is contiguous with the second connecting wall portion. A portion of the second coupling wall portion extends along a fourth slope from the second connecting wall portion. The fourth slope has a fourth angle along the reference plane. The fourth angle is less than the third angle. The coupler portion is contiguous with the first coupling wall portion and the second coupling wall portion. The aftertreatment system component is positioned within the aftertreatment component housing.

Another embodiment includes a method for installing an aftertreatment component cartridge in an aftertreatment system having an inlet conduit assembly, an outlet conduit assembly, and a clamp. The inlet conduit assembly includes an inlet body with an inlet body wall portion and an inlet coupling flange portion. The outlet conduit assembly includes an outlet body with an outlet body wall portion and an outlet coupling flange portion. The aftertreatment component cartridge includes an aftertreatment component housing with an inlet portion and an outlet portion, and an adaptor with a first flange portion coupled to the aftertreatment component housing, a second flange portion coupled to the aftertreatment component housing, a first coupling wall portion contiguous with the first flange portion and having a portion that extends along a first slope from the first flange portion, and a second coupling wall portion contiguous with the second flange portion and having a portion that extends along a second slope from the second flange portion. The clamp includes a first clamp flange portion and a second clamp flange portion. The method for installing the aftertreatment component cartridge in the aftertreatment system includes the steps of inserting the inlet portion into the inlet body such that the first flange portion is disposed between the aftertreatment component housing and the inlet body wall portion, and inserting the outlet portion into the outlet body such that the second flange portion is disposed between the aftertreatment component housing and the outlet body wall portion. Next, the first coupling wall portion and the inlet coupling flange portion are brought into confronting relation, and the second coupling wall portion and the outlet coupling flange portion are brought into confronting relation.

### BRIEF DESCRIPTION OF THE DRAWINGS

The disclosure will become more fully understood from the following detailed description, taken in conjunction with the accompanying Figures, wherein like reference numerals refer to like elements unless otherwise indicated, in which:

FIG. 1 is a side view of an example aftertreatment system;

FIG. 2 is an perspective exploded view of the aftertreatment system shown in FIG. 1;

FIG. 3 is a cross-sectional view of the aftertreatment system shown in FIG. 1 taken along plane A-A, in an example embodiment;

FIG. 4 is a detailed view of Detail A in FIG. 3;

FIG. 5 is a cross-sectional view of an example aftertreatment system shown in FIG. 1 taken along plane A-A, in an example embodiment;

FIG. 6 is a cross-sectional view of the aftertreatment system shown in FIG. 1 taken along plane A-A, in an example embodiment;

FIG. 7 is a cross-sectional view of the aftertreatment system shown in FIG. 1 taken along plane A-A, in an example embodiment;

FIG. 8 is a detailed view of Detail B in FIG. 6;

FIG. 9 is a cross-sectional view of the aftertreatment system shown in FIG. 1 taken along plane A-A, in an example embodiment;

FIG. 10 is a cross-sectional view of the aftertreatment system shown in FIG. 1 taken along plane A-A, in an example embodiment;

| FIG. 11 is a detailed view of Detail C in FIG. 9;

FIG. 12 is a cross-sectional view of the aftertreatment system shown in FIG. 1 taken along plane A-A, in an example embodiment;

FIG. 13 is a cross-sectional view of the aftertreatment system shown in FIG. 1 taken along plane A-A, in an example embodiment;

FIG. 14 is a detailed view of Detail D in FIG. 12;

FIG. 15 is a flowchart illustrating the process for installing an aftertreatment component cartridge of the aftertreatment system; and

FIG. 16 is a flowchart illustrating the process for replacing the aftertreatment component cartridge of the aftertreatment system.

It will be recognized that the Figures are the schematic representations for purposes of illustration. The Figures are provided for the purpose of illustrating one or more implementations with the explicit understanding that the Figures will not be used to limit the scope of the meaning of the claims.

### DETAILED DESCRIPTION

Following below are more detailed descriptions of various concepts related to, and implementations of, methods, apparatuses, and for providing an aftertreatment component cartridge for an aftertreatment system. The various concepts introduced above and discussed in greater detail below may be implemented in any of a number of ways, as the described concepts are not limited to any particular manner of implementation. Examples of specific implementations and applications are provided primarily for illustrative purposes.

### I. Overview

In order to reduce emissions, it may be desirable to treat exhaust gas using an aftertreatment system component. After the aftertreatment system component has treated a certain amount of exhaust gas, the aftertreatment system component may need to be serviced or replaced. Additionally, it may occasionally be desired to remove the aftertreatment component cartridge and replace the aftertreatment system component with a different aftertreatment system component, thereby repurposing the aftertreatment system from one application to another. Removing, servicing, and replacing the aftertreatment system component may be difficult or impossible in many aftertreatment systems because the aftertreatment system component is not removable and/or not easily accessible by a user. One approach for servicing and replacing of aftertreatment system components is to secure the aftertreatment system components to the aftertreatment system with multiple clamps. However, the use of multiple clamps increases the overall cost and space of the aftertreatment system, limiting the space available for other systems. The use of multiple clamps also reduces the area available on the exterior of the aftertreatment system for insulation. Furthermore, using multiple clamps increases the number of joints and openings for exhaust gas to escape, which may increase the temperature of the aftertreatment system exterior and surrounding components.

Aftertreatment systems are defined by a space claim, which is the amount of physical space that an aftertreatment system consumes when installed (e.g., on a vehicle, etc.) and the location (e.g., coordinates relative to a vehicle coordinate system, etc.) of the physical space that is consumed by the aftertreatment system when installed. In some applications, the physical space available for use by an aftertreatment system is limited due to the locations of surrounding components, wiring or piping requirements, or other similar constraints. As such, it is often difficult to modify an aftertreatment system because such modifications typically increase the space claim of the aftertreatment system. Such modifications may be desired to utilize various components, such as different types of filters or catalysts, in the aftertreatment system.

Implementations described herein are related to an aftertreatment system with an inlet conduit assembly, an outlet conduit assembly, and at least one aftertreatment component cartridge containing an aftertreatment system component. The inlet conduit assembly includes an inlet coupling flange portion, and the outlet conduit assembly includes an outlet coupling flange portion. The aftertreatment component cartridge includes an adaptor that cooperates with the inlet coupling flange and the outlet coupling flange and facilitates suspension of the aftertreatment system component within a housing by using a fastener (e.g., clamp, bolted joint, V-band body joint, etc.) to fix the aftertreatment component cartridge to the inlet body and outlet body. In this way, internal combustion engines utilizing the aftertreatment system described herein are more desirable than other aftertreatment systems with multiple clamps and that cannot be rapidly installed, serviced, replaced, and repurposed (e.g., by changing a type of one or more of the aftertreatment components, etc.). Furthermore, by configuring the inlet coupling flange and the outlet coupling flange and the adaptor to be held by a fastener in this arrangement, a space claim of the aftertreatment system described herein may be significantly smaller than other systems that do not utilize such an arrangement. Additionally, by using a fastener in this arrangement, there is increased area on an exterior of the aftertreatment system for insulation and a reduced number of joints and openings from which exhaust gas may escape.

### II. Overview of Example Aftertreatment Systems

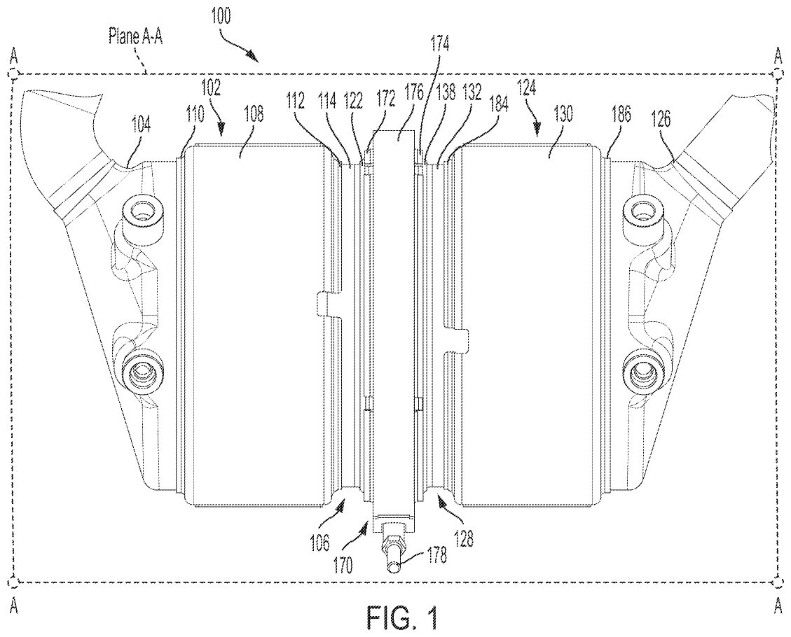

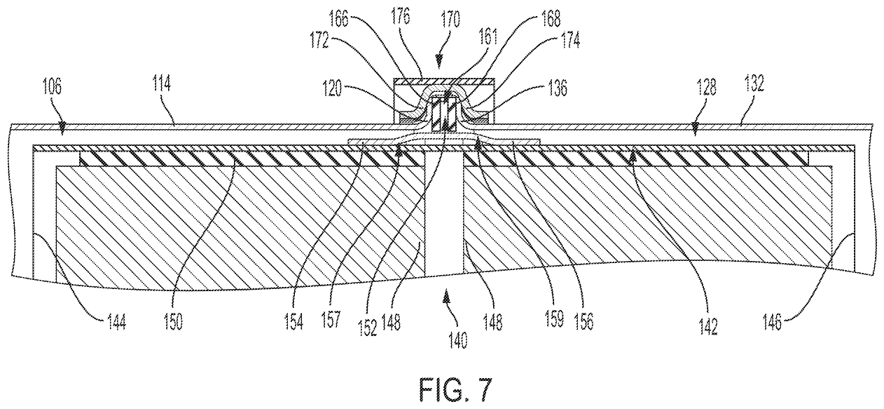

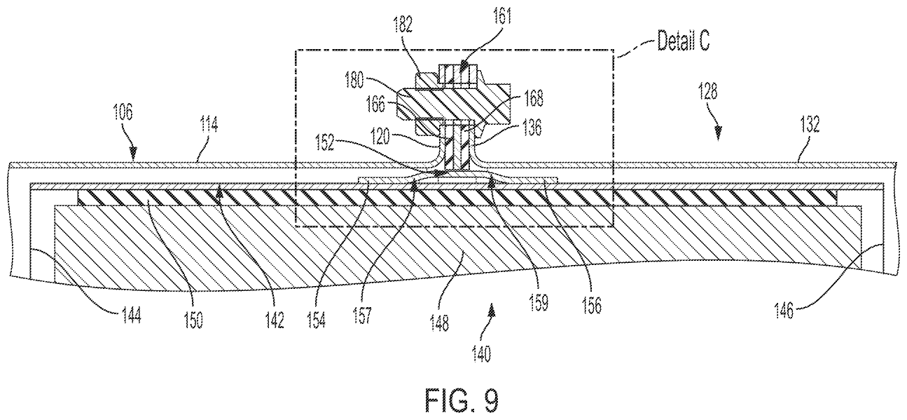

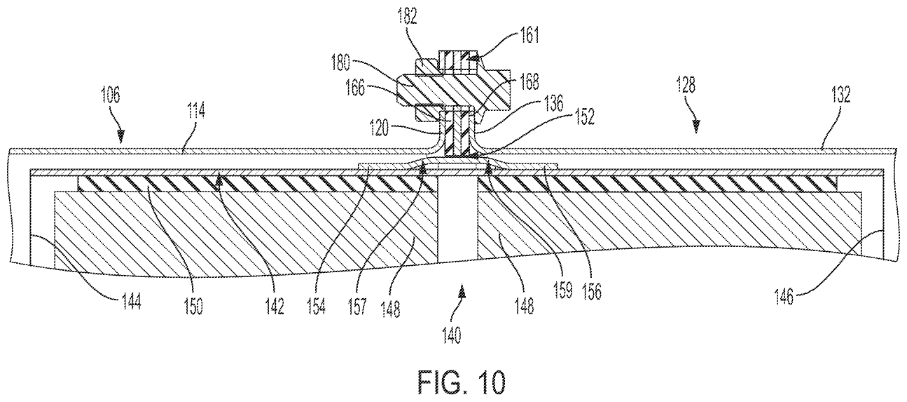

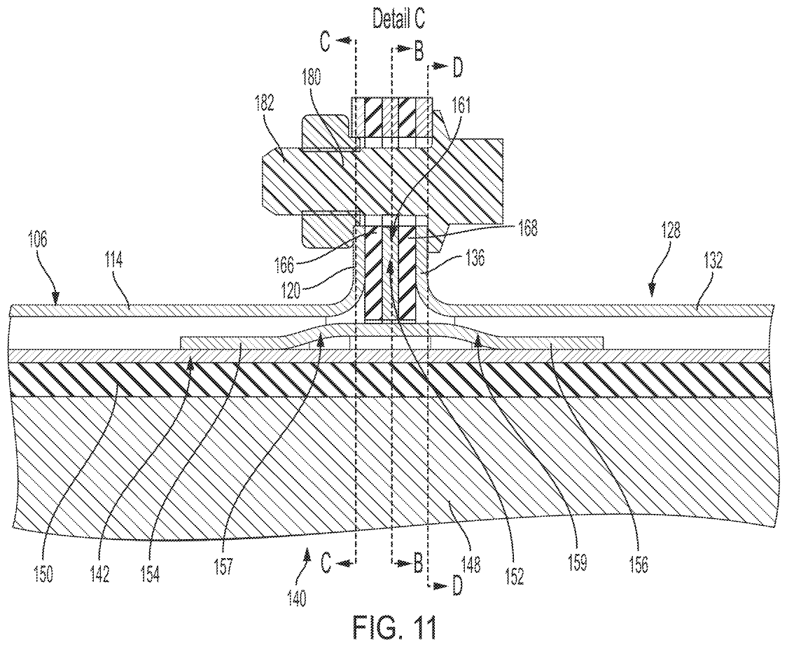

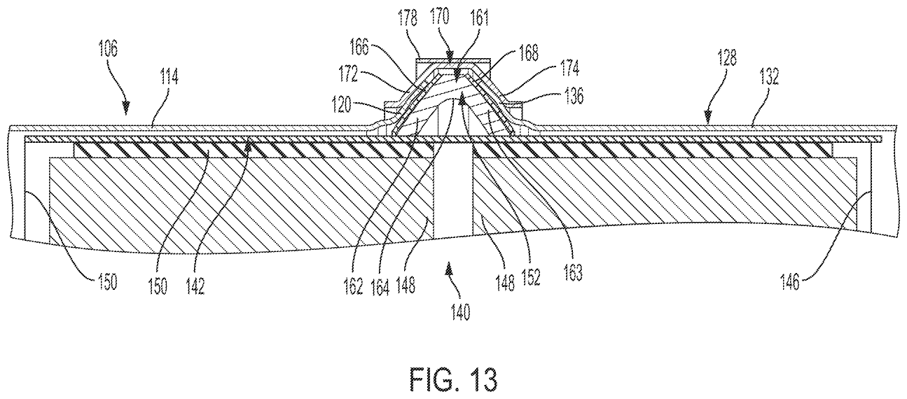

FIGS. 1-14 depict an aftertreatment system 100 (e.g., treatment system, etc.) for treating exhaust gas produced by an internal combustion engine (e.g., diesel internal combustion engine, gasoline internal combustion engine, hybrid internal combustion engine, propane internal combustion engine, dual-fuel internal combustion engine, etc.). As explained in more detail herein, the aftertreatment system 100 facilitates simplified and faster servicing than other systems (e.g., by changing a type of one or more of the aftertreatment components, etc.), thereby making the aftertreatment system 100 more desirable than other systems.

The aftertreatment system 100 includes an inlet conduit assembly 102 (e.g., line system, pipe system, etc.). The inlet conduit assembly 102 includes an inlet exhaust pipe 104 (e.g., pipe system, etc.) that receives an exhaust gas from an upstream component (e.g., header on the internal combustion engine, exhaust manifold on the internal combustion engine, the internal combustion engine, etc.). In some embodiments, the inlet exhaust pipe 104 is coupled (e.g., attached, fixed, welded, fastened, riveted, adhesively attached, bonded, pinned, etc.) to the upstream component. In other embodiments, the inlet exhaust pipe 104 is integrally formed with the upstream component.

The inlet conduit assembly 102 also includes an inlet body 106 (e.g., body, panel, etc.). The inlet conduit assembly 102 also includes an inlet shell 108 (e.g., shell, body, etc.). The inlet shell 108 surrounds the inlet body 106 to contain the inlet body 106. The inlet shell 108 includes a first inlet shell flange 110 (e.g. ring-shaped projection, circular protuberance, annular rib, etc.) to couple the inlet shell 108 to the inlet body 106. The inlet shell 108 also includes a second inlet shell flange 112 (e.g. ring-shaped projection, circular protuberance, annular rib, etc.) to couple the inlet shell 108 to the inlet body 106. The inlet body 106 includes an inlet body wall portion 114 (e.g., body, panel, etc.). The inlet body wall portion 114 receives the flow of exhaust gas from the inlet exhaust pipe 104.

In some embodiments, the inlet exhaust pipe 104 includes an inlet exhaust pipe flange 116 (e.g. ring-shaped projection, circular protuberance, annular rib, etc.) disposed between and coupled to the inlet body wall portion 114 and the first inlet shell flange 110. The inlet exhaust pipe flange 116 may facilitate coupling of the inlet exhaust pipe 104 to the inlet conduit assembly 102.

In some embodiments, the inlet conduit assembly 102 also includes an inlet insulator 118 (e.g., insulator, mat, etc.). The inlet insulator 118 is disposed between the inlet body wall portion 114 and the inlet shell 108. The inlet insulator 118 functions to mitigate increases in temperature of the inlet shell 108 as exhaust gas enters the inlet conduit assembly 102. The inlet insulator 118 may be, for example, an insulating mat, a mat of ceramic fibers, or other similar components.

The inlet body 106 also includes an inlet coupling flange portion 120 (e.g. ring-shaped projection, circular protuberance, annular rib, etc.). The inlet coupling flange portion 120 is downstream of the inlet body wall portion 114 and flares outwardly (e.g., radially outwardly and axially outwardly, etc.) from the inlet body wall portion 114. More specifically, the inlet coupling flange portion 120 extends along a slope from the inlet body wall portion 114. The slope has an angle along a reference plane bisecting the inlet body 106.

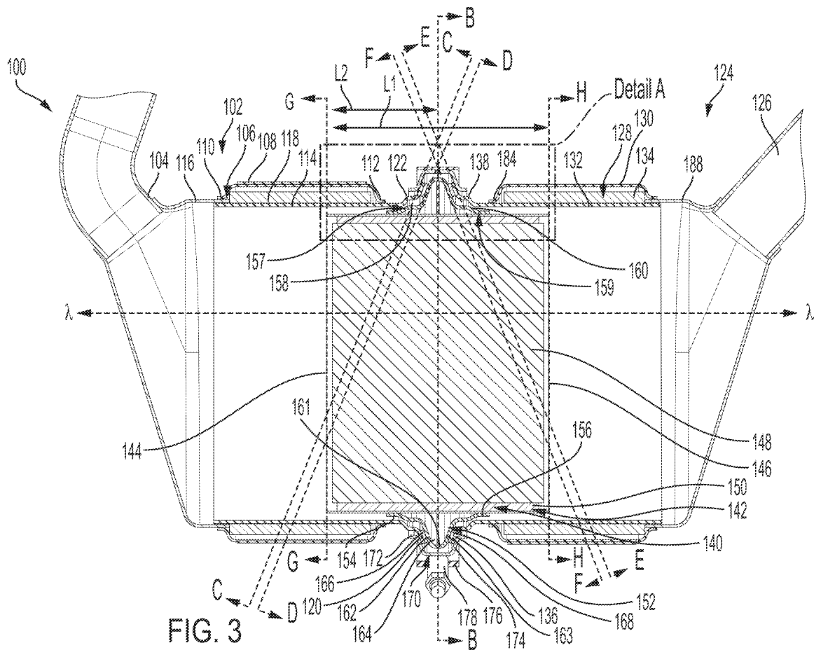

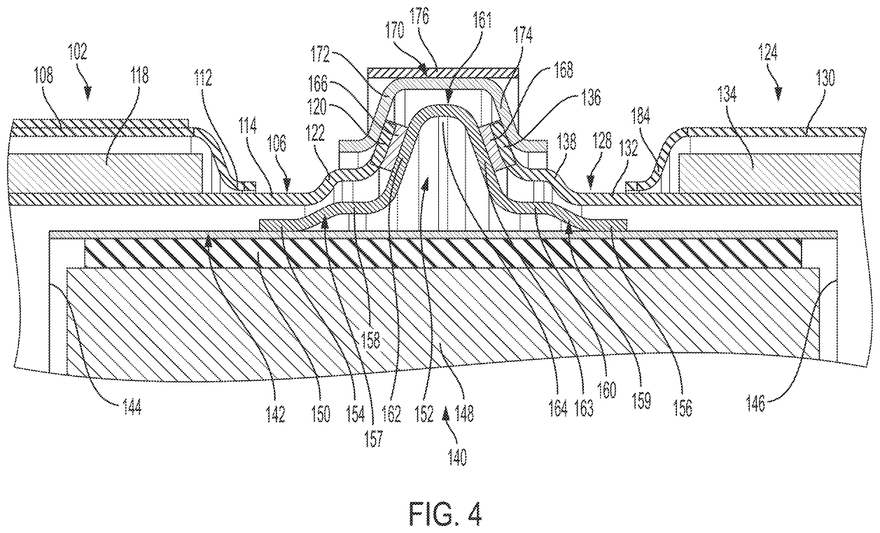

In some embodiments, the inlet body 106 also includes an inlet curved portion 122, as seen in FIGS. 3-5. The inlet curved portion 122 is contiguous with the inlet body wall portion 114 and the inlet coupling flange portion 120. Similar to the inlet coupling flange portion 120, the inlet curved portion 122 is flared outwardly. More specifically, the inlet curved portion 122 extends along a slope from the inlet body wall portion 114, and the inlet coupling flange portion 120 extends along a slope from the inlet curved portion 122. As a result, the inlet curved portion 122 creates a gap in the interior of the aftertreatment system 100 to accommodate another component, such as described in more detail herein. The slopes have angles along a reference plane bisecting the inlet body 106. The angle of the slope of the inlet coupling flange portion 120 is greater than the angle of the slope of the inlet curved portion 122 (e.g., where the angle is measured in the counterclockwise direction in FIG. 4, etc.). For example, the difference in angle may be approximately equal to between 10 degrees and 30 degrees. This difference in angle enables the inlet body 106 to have a shape that facilitates coupling to other components of the aftertreatment system 100, as described in more detail herein.

Referring back to FIGS. 1-14, as explained in more detail below, the aftertreatment system 100 also includes an outlet conduit assembly 124 (e.g., line system, pipe system, etc.). As is explained in more detail herein, the outlet conduit assembly 124 is configured to provide the exhaust gas from the aftertreatment system 100 (e.g., to downstream components, to atmosphere, etc.).

The outlet conduit assembly 124 includes an outlet exhaust pipe 126 (e.g., line system, pipe system, etc.). The outlet exhaust pipe 126 provides the exhaust gas from the aftertreatment system 100. The outlet conduit assembly 124 also includes an outlet body 128 (e.g., body, panel, etc.). The outlet conduit assembly 124 also includes an outlet shell 130 (e.g., shell, body, etc.). The outlet shell 130 surrounds the outlet body 128 to contain the outlet body 128. The outlet body 128 includes an outlet body wall portion 132 (e.g., body, panel, etc.).

In some embodiments, the outlet conduit assembly 124 also includes an outlet insulator 134 (e.g., insulator, mat, etc.). The outlet insulator 134 is disposed between the outlet body wall portion 132 and the outlet shell 130. The outlet insulator 134 functions to mitigate an increase in temperature of the outlet shell 130. The outlet insulator 134 may be, for example, an insulating mat, a mat of ceramic fibers, or other similar components.

The outlet body 128 also includes an outlet coupling flange portion 136 (e.g., ring-shaped projection, circular protuberance, annular rib, etc.). The outlet coupling flange portion 136 is upstream of the outlet body wall portion 132 and flares outwardly from the outlet body wall portion 132. More specifically, the outlet coupling flange portion 136 extends along a slope from the outlet body wall portion 132. The outlet coupling flange portion 136 extends along a slope from the outlet body wall portion 132 in a first direction and the inlet coupling flange portion 120 extends along a slope from the inlet body wall portion 114 in a second direction that is opposite to the first direction. The outlet coupling flange portion 136 extends along a slope from the outlet body wall portion 132 in a first direction and the inlet coupling flange portion 120 extends along a slope from the inlet body wall portion 114 in the first direction.

In some embodiments, the outlet body 128 also includes an outlet curved portion 138, as seen in FIGS. 3-5. The outlet curved portion 138 is contiguous with the outlet body wall portion 132 and the outlet coupling flange portion 136. Similar to the outlet coupling flange portion 136, the outlet curved portion 138 is flared outwardly. More specifically, the outlet curved portion 138 extends along a slope from the outlet body wall portion 132, and the outlet coupling flange portion 136 extends along a slope from the outlet curved portion 138. The outlet curved portion 138 extends along a slope from the outlet body wall portion 132 in a first direction and the inlet coupling flange portion 120 extends along a slope from the inlet body wall portion 114 in a second direction that is opposite to the first direction. The outlet curved portion 138 extends along a slope from the outlet body wall portion 132 in a first direction and the inlet coupling flange portion 120 extends along a slope from the inlet body wall portion 114 in the first direction. As a result, the outlet curved portion 138 creates a gap in an interior of the aftertreatment system 100 that can receive another component, such as described in more detail herein. The slopes have angles along a reference plane bisecting the outlet body 128. The angle of the slope of the outlet curved portion 138 is greater than the angle of the slope of the outlet coupling flange portion 136 (e.g., where the angle is measured in the counterclockwise direction in FIG. 4, etc.). For example, the difference in angle may be approximately equal to between 10 degrees and 30 degrees. This difference in angle enables the outlet body 128 to have a shape that facilitates coupling to other components of the aftertreatment system 100, as described in more detail herein.

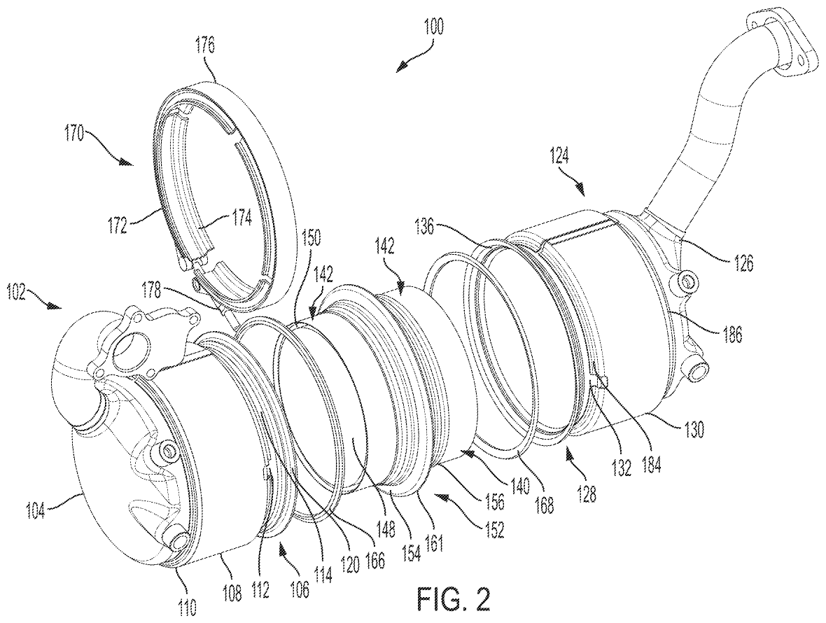

In FIGS. 2-4, the aftertreatment system 100 includes an aftertreatment component cartridge 140 (e.g., cartridge, insert, etc.). As explained in more detail herein, the inlet coupling flange portion 120 and the outlet coupling flange portion 136 cooperate to facilitate suspension of the aftertreatment component cartridge 140 within the inlet body 106 and the outlet body 128.

As shown in FIG. 4, the aftertreatment component cartridge 140 includes an aftertreatment component housing 142 (e.g., filtering housing, etc.). The aftertreatment component housing 142 facilitates flow of the exhaust gas from the inlet conduit assembly 102 into the aftertreatment component cartridge 140.

The aftertreatment component housing 142 includes an inlet portion 144. The inlet portion 144 is inserted into the inlet conduit assembly 102. The inlet portion 144 receives the exhaust gas from the inlet conduit assembly 102, and provides the exhaust gas into the aftertreatment component cartridge 140. The aftertreatment component housing 142 also includes an outlet portion 146. The outlet portion 146 is inserted into the outlet conduit assembly 124. The outlet portion 146 receives the exhaust gas from the aftertreatment component cartridge 140, and provides the exhaust gas from the aftertreatment component cartridge 140.

As shown in FIGS. 2-4, the aftertreatment component cartridge 140 includes an aftertreatment system component 148. The aftertreatment system component 148 is positioned within the aftertreatment component housing 142. The aftertreatment system component 148 treats the exhaust gas produced by an internal combustion engine. In some embodiments, the aftertreatment system component 148 reduces the emission of undesirable components (e.g., nitrogen oxides (NOx), etc.) in the exhaust gas. In some embodiments, the aftertreatment system component 148 facilitates the removal of particulate (e.g., soot, particulate matter, etc.) from the exhaust gas by a filtration member (e.g., a diesel particulate filter (DPF), etc.). In other embodiments, the aftertreatment system component 148 is a conversion catalyst member (e.g., selective catalytic reduction (SCR) conversion catalyst member, catalyst metals, etc.) that facilitates conversion of various oxidation components (e.g., carbon monoxide (CO), hydrocarbons, etc.) of the exhaust gas into other components (e.g., carbon dioxide (CO₂), water vapor, etc.).

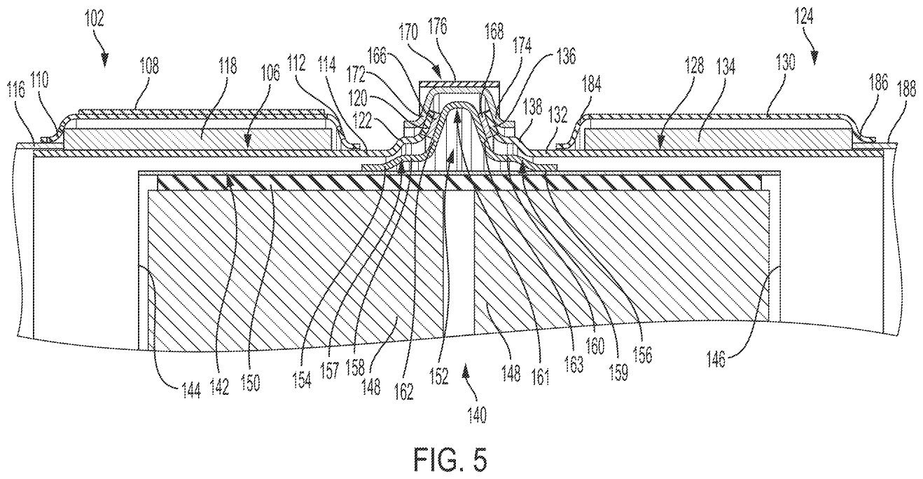

As seen in FIGS. 5, 7, 10, and 13, the aftertreatment component cartridge 140 is not limited to housing a single aftertreatment system component 148. Rather, the aftertreatment component cartridge 140 may contain more than one aftertreatment system component 148, each aftertreatment system component 148 able to be any of the embodiments described herein. In some embodiments, both of the aftertreatment system components 148 are the same. For example, both of the aftertreatment system components 148 may be conversion catalyst members. In another example, both of the aftertreatment system components 148 may be filtration members. In other embodiments, the aftertreatment system components 148 are different from one another. For example, the upstream aftertreatment system component 148 may be a filtration member and the downstream aftertreatment system component 148 may be a conversion catalyst member.

In some embodiments, the aftertreatment component cartridge 140 also includes a mounting mat 150 (e.g., compressible mat, etc.). The mounting mat 150 is disposed between the aftertreatment system component 148 and the aftertreatment component housing 142. The mounting mat 150 may facilitate coupling of the aftertreatment system component 148 and the aftertreatment component housing 142.

Referring back to FIG. 4, the aftertreatment component cartridge 140 includes an adaptor 152 (e.g., projection, protuberance, rib, etc.). The adaptor 152 is coupled to the aftertreatment component housing 142. The adaptor 152 cooperates with the aftertreatment component housing 142, the inlet coupling flange portion 120, and the outlet coupling flange portion 136 to facilitate suspension of the aftertreatment component cartridge 140 within the inlet body 106 and the outlet body 128 when a compressive force is applied to the adaptor 152. Different embodiments of the adaptor 152 enable use of different fasteners (e.g., clamps, compression joints, V-band body joints, etc.) to compress the adaptor 152 and suspend the aftertreatment component cartridge 140 within the inlet body 106 and the outlet body 128, as described in more detail herein.

In some embodiments, the adaptor 152 comprises a first flange portion 154 (e.g., ring, etc.) coupled to the inlet portion 144, and a second flange portion 156 (e.g., ring, etc.) coupled to the outlet portion 146. By coupling the first flange portion 154 to the inlet portion 144 and the second flange portion 156 to the outlet portion 146, the first flange portion 154 and the second flange portion 156 facilitate suspension of the aftertreatment component cartridge 140 within the inlet body 106 and the outlet body 128 when a compressive force is applied to the adaptor 152. When the first flange portion 154 is coupled to the inlet portion 144, the first flange portion 154 is disposed between the inlet body wall portion 114 and the inlet portion 144. Similarly, when the second flange portion 156 is coupled to the outlet portion 146, the second flange portion 156 is disposed between the outlet body wall portion 132 and the outlet portion 146. In some embodiments, a user may receive the aftertreatment component cartridge 140 with the first flange portion 154 already coupled to the inlet portion 144 and the second flange portion 156 already coupled to the outlet portion 146.

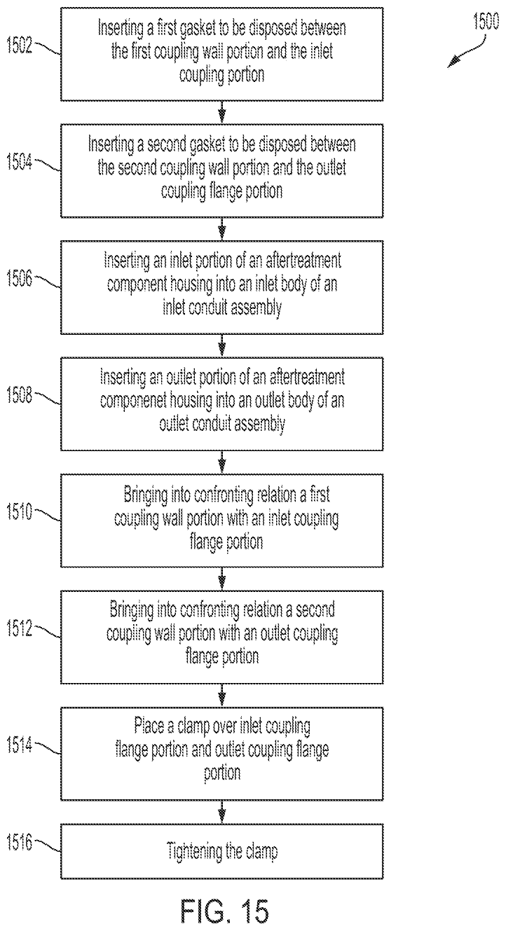

In other embodiments, the first flange portion 154 and the second flange portion 156 are initially separate from the inlet portion 144 and the outlet portion 146, respectively. In these embodiments, a user may couple the first flange portion 154 to the inlet portion 144 and the second flange portion 156 to the outlet portion 146 during an installation process (e.g., method, etc.) for installing an aftertreatment component cartridge 140 of the aftertreatment system 100. Various examples of such an installation process are described with reference to FIG. 15.

In some embodiments, the adaptor 152 includes a first connecting wall portion 157. The first connecting wall portion 157 is contiguous with the first flange portion 154. A portion of the first connecting wall portion 157 extends along a slope from the first flange portion 154. As shown in FIG. 3, the first connecting wall portion 157 includes a first flat portion 158. The first flat portion 158 is contiguous with the first connecting wall portion 157. The first flat portion 158 is parallel to a center axis λ.

Similarly, in some embodiments, the adaptor 152 includes a second connecting wall portion 159. The second connecting wall portion 159 is contiguous with the second flange portion 156. A portion of the second connecting wall portion 159 extends along a slope from the second flange portion 156. As shown in FIG. 3, the second connecting wall portion 159 includes a second flat portion 160. The second flat portion 160 is contiguous with the second connecting wall portion 159. The second flat portion 160 is parallel to the center axis λ

Further, the adaptor 152 includes a coupler portion 161 (e.g. ring-shaped projection, circular protuberance, annular rib, etc.), as seen in FIG. 4. The coupler portion 161 is disposed between and connects the first flange portion 154 and the second flange portion 156. In this way, when a compressive force is applied to the adaptor 152, the coupler portion 161 enables the first flange portion 154 to suspend the inlet portion 144 while also enabling the second flange portion 156 to suspend the outlet portion 146. Additionally, the coupler portion 161 extends between the inlet coupling flange portion 120 of the inlet body 106 and the outlet coupling flange portion 136 of the outlet body 128.

In some embodiments, the coupler portion 161 includes a first coupling wall portion 162 (e.g., plate, body, etc.). The first coupling wall portion 162 cooperates with the inlet coupling flange portion 120 to suspend the aftertreatment component cartridge 140. Similarly, the coupler portion 161 includes a second coupling wall portion 163 (e.g., plate, body, etc.). The second coupling wall portion 163 cooperates with outlet coupling flange portion 136 to suspend the aftertreatment component cartridge 140.

The first coupling wall portion 162 is downstream of and contiguous with the first flange portion 154. The first coupling wall portion 162 extends along a slope from the first flange portion 154 such that the first coupling wall portion 162 is parallel with the inlet coupling flange portion 120, resulting in the inlet coupling flange portion 120 and the first coupling wall portion 162 being in confronting relation. The slopes have angles along a reference plane bisecting the adaptor 152. The angle of the slope of the first coupling wall portion 162 is greater than the angle of the slope of the first connecting wall portion 157 (e.g., where the angle is measured in the counterclockwise direction in FIG. 4, etc.). For example, the difference in angle may be approximately equal to between 20 degrees and 80 degrees. This difference in angle enables the adaptor 152 to have a shape that facilitates coupling to other components of the aftertreatment system 100, as described in more detail herein. In some embodiments, the first coupling wall portion 162 is contiguous with the first connecting wall portion 157, and a portion of the first coupling wall portion 162 extends along a slope from the first connecting wall portion 157.

The second coupling wall portion 163 is upstream of and contiguous with the second flange portion 156. The second coupling wall portion 163 extends along a slope from the second flange portion 156 such that the second coupling wall portion 163 is parallel with the outlet coupling flange portion 136, resulting in the outlet coupling flange portion 136 and second coupling wall portion 163 being in confronting relation. The slopes have angles along a reference plane bisecting the adaptor 152. The angle of the slope of the second connecting wall portion 159 is greater than the angle of the slope of the second coupling wall portion 163 (e.g., where the angle is measured in the counterclockwise direction in FIG. 4, etc.). For example, the difference in angle may be approximately equal to between 20 degrees and 80 degrees. This difference in angle enables the adaptor 152 to have a shape that facilitates coupling to other components of the aftertreatment system 100, as described in more detail herein. In some embodiments, the second coupling wall portion 163 is contiguous with the second connecting wall portion 159, and a portion of the second coupling wall portion 163 extends along a slope from the second connecting wall portion 159.

Consequently, when a compressive force is applied to the inlet coupling flange portion 120 and the outlet coupling flange portion 136, the compressive force is also applied to the first coupling wall portion 162 and the second coupling wall portion 163, enabling the adaptor 152 to suspend the aftertreatment system component 148 within the inlet body 106 and the outlet body 128.

The adaptor 152 also includes a radial wall portion 164 (e.g., plate, body, etc.). The radial wall portion 164 extends between the first coupling wall portion 162 and the second coupling wall portion 163 is. The radial wall portion 164 is contiguous with the first coupling wall portion 162 and the second coupling wall portion 163 and is radially separated from the aftertreatment component housing 142.

Referring to FIGS. 2-4, in some embodiments, the aftertreatment system 100 includes a first gasket 166 (e.g., spacers, seals, plugs, etc.). The first gasket 166 may be made of a compressible material (e.g., rubber, elastomer, etc.). The first gasket 166 is disposed between the inlet coupling flange portion 120 and the first coupling wall portion 162 such that the first gasket 166 is separated from the aftertreatment component housing 142 by the adaptor 152. The first gasket 166 establishes a seal between the inlet coupling flange portion 120 and the first coupling wall portion 162. In this way, when a compressive force is applied to the inlet coupling flange portion 120, the first gasket 166 is compressed between the inlet coupling flange portion 120 and the first coupling wall portion 162.

Similarly, the aftertreatment system 100 may include a second gasket 168 (e.g., spacers, seals, plugs, etc.). The second gasket 168 may be made of a compressible material (e.g. rubber, elastomer, etc.). The second gasket 168 is disposed between the outlet coupling flange portion 136 and the second coupling wall portion 163 such that the second gasket 168 is separated from the aftertreatment component housing 142 by the adaptor 152. The second gasket 168 establishes a seal between the outlet coupling flange portion 136 and the second coupling wall portion 163. In this way, when a compressive force is applied to the outlet coupling flange portion 136, the second gasket 168 is compressed between the outlet coupling flange portion 136 and the second coupling wall portion 163. Both the first gasket 166 and second gasket 168 may be creep resistant so that joint preload does not substantially decrease over prolonged compression of the inlet coupling flange portion 120 and the outlet coupling flange portion 136 with the first coupling wall portion 162 and the second coupling wall portion 163.

In another embodiment, only the first gasket 166 is utilized. When only the first gasket 166 is utilized, the first gasket 166 is disposed between the first coupling wall portion 162, the inlet coupling flange portion 120, the second coupling wall portion 163, and the outlet coupling flange portion 136 such that the first gasket 166 is separated from the aftertreatment component housing 142 by the adaptor 152. The first gasket 166 establishes a seal between the first coupling wall portion 162, the inlet coupling flange portion 120, the second coupling wall portion 163, and the outlet coupling flange portion 136. In this way, when a compressive force is applied to the inlet coupling flange portion 120, the first gasket 166 is compressed between the inlet coupling flange portion 120 and the first coupling wall portion 162. When a compressive force is applied to the outlet coupling flange portion 136, the first gasket 166 is compressed between the outlet coupling flange portion 136 and the second coupling wall portion 163. The first gasket 166 may be creep resistant so that joint preload does not substantially decrease over prolonged compression of the inlet coupling flange portion 120 and the outlet coupling flange portion 136 with the first coupling wall portion 162 and second coupling wall portion 163.

Referring back to FIG. 3, in some embodiments, the aftertreatment system 100 is centered on the center axis λ. The aftertreatment component cartridge 140 is bisected by the radial plane B-B that intersects the center axis λ and is orthogonal to the center axis λ. Further, at least a portion of the inlet coupling flange portion 120 is disposed along an inlet coupling flange plane C-C. The inlet coupling flange plane C-C is separated from the radial plane B-B by an angle that is approximately equal to between 10 degrees and 30 degrees (e.g., 5 degrees, 10 degrees, 15 degrees, 25 degrees, 30 degrees, 35 degrees, etc.). Similarly, at least a portion of the first coupling wall portion 162 is disposed along a first coupling wall plane D-D. The first coupling wall plane D-D is separated from the radial plane B-B by an angle that is approximately equal to between 10 degrees and 30 degrees (e.g., 5 degrees, 10 degrees, 15 degrees, 25 degrees, 30 degrees, 35 degrees, etc.).

In some of these embodiments, the inlet coupling flange plane C-C and the first coupling wall plane D-D are separated from the radial plane B-B by equal angles. Therefore, the first coupling wall portion 162 is parallel with the inlet coupling flange portion 120.

In some embodiments, at least a portion of the outlet coupling flange portion 136 is disposed along an outlet coupling flange plane E-E. The outlet coupling flange plane E-E is separated from the radial plane B-B by an angle that is approximately equal to between 280 degrees and 300 degrees (e.g., 275 degrees, 280 degrees, 285 degrees, 295 degrees, 300 degrees, 305 degrees, etc.). Similarly, at least a portion of the second coupling wall portion 163 is disposed along a second coupling wall plane F-F. The second coupling wall plane F-F is separated from the radial plane B-B by an angle that is approximately equal to between 280 degrees and 300 degrees (e.g., 275 degrees, 280 degrees, 285 degrees, 295 degrees, 300 degrees, etc.).

In some of these embodiments, the outlet coupling flange plane E-E and the second coupling wall plane F-F are separated from the radial plane B-B by equal angles. Therefore, the second coupling wall portion 163 is parallel with the outlet coupling flange portion 136.

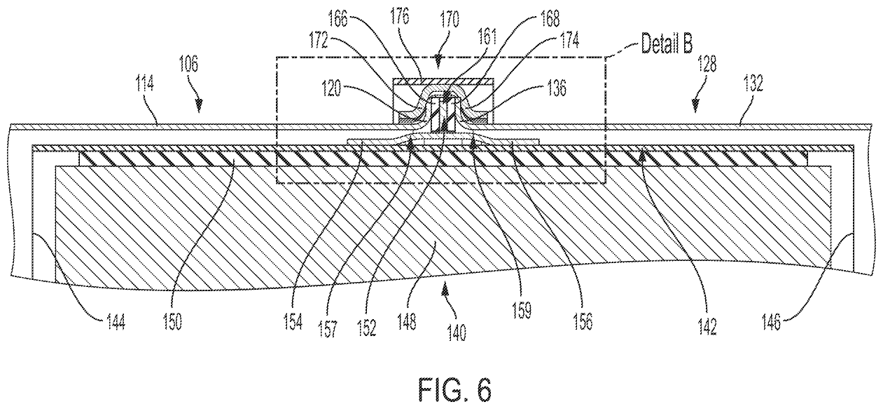

As previously mentioned, different embodiments of the adaptor 152 enable different fasteners to be used to compress the adaptor 152 and facilitate suspension of the aftertreatment component cartridge 140 within the inlet body 106 and the outlet body 128. FIGS. 6-11 are cross-sectional views of the aftertreatment system 100 depicting embodiments with different adaptors 152. For example, in the embodiments in FIGS. 6-8, the coupler portion 161 of the adaptor 152 is coupled to the first flange portion 154 and the second flange portion 156. The coupler portion 161 is positioned radially outward from the aftertreatment component housing 142 such that the coupler portion 161 is orthogonal to the aftertreatment component housing 142. When a compressive force is applied to the inlet coupling flange portion 120 and the outlet coupling flange portion 136, the coupler portion 161 is compressed between the inlet coupling flange portion 120 and the outlet coupling flange portion 136. By compressing the coupler portion 161, the adaptor 152 is able to suspend the aftertreatment system component 148 within the aftertreatment system 100 by fixing the aftertreatment component cartridge 140 to the inlet body 106 and the outlet body 128.

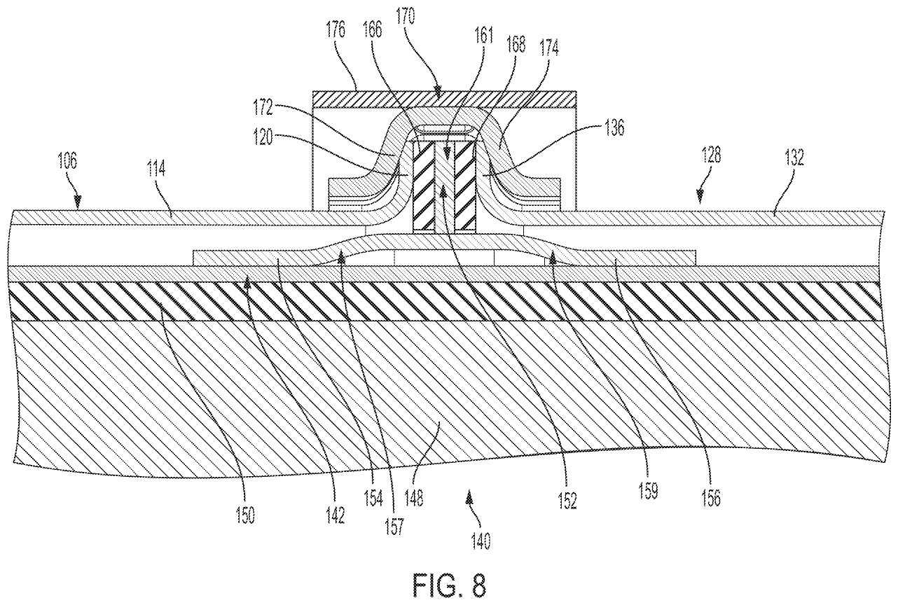

As seen, for example, in FIGS. 8 and 11, in some embodiments, the aftertreatment system 100 includes the first gasket 166. The first gasket 166 is disposed between the inlet coupling flange portion 120 and the coupler portion 161 such that the first gasket 166 is separated from the aftertreatment component housing 142 by the adaptor 152. The first gasket 166 establishes a seal between the inlet coupling flange portion 120 and the coupler portion 161. In this way, when a compressive force is applied to the inlet coupling flange portion 120, the first gasket 166 is compressed between the inlet coupling flange portion 120 and the coupler portion 161.

The second gasket 168 is disposed between the outlet coupling flange portion 136 and the coupler portion 161 such that the second gasket 168 is separated from the aftertreatment component housing 142 by the adaptor 152. The second gasket 168 establishes a seal between the outlet coupling flange portion 136 and the coupler portion 161. In this way, when a compressive force is applied to the outlet coupling flange portion 136, the second gasket 168 is compressed between the outlet coupling flange portion 136 and the coupler portion 161. Both the first gasket 166 and the second gasket 168 may be creep resistant so that joint preload does not substantially decrease over prolonged compression of the inlet coupling flange portion 120 and the outlet coupling flange portion 136 with the coupler portion 161.

Referring to FIG. 11, the aftertreatment component cartridge 140 is bisected by the radial plane B-B that intersects the center axis 2 and is orthogonal to the center axis 2. Further, at least a portion of the inlet coupling flange portion 120 is disposed along the inlet coupling flange plane C-C, and at least a portion of the outlet coupling flange portion 136 is disposed along the outlet coupling flange plane D-D. The inlet coupling flange plane C-C and the outlet coupling flange plane D-D are orthogonal to the center axis 2. Therefore, the inlet coupling flange portion 120 is parallel with the outlet coupling flange portion 136.

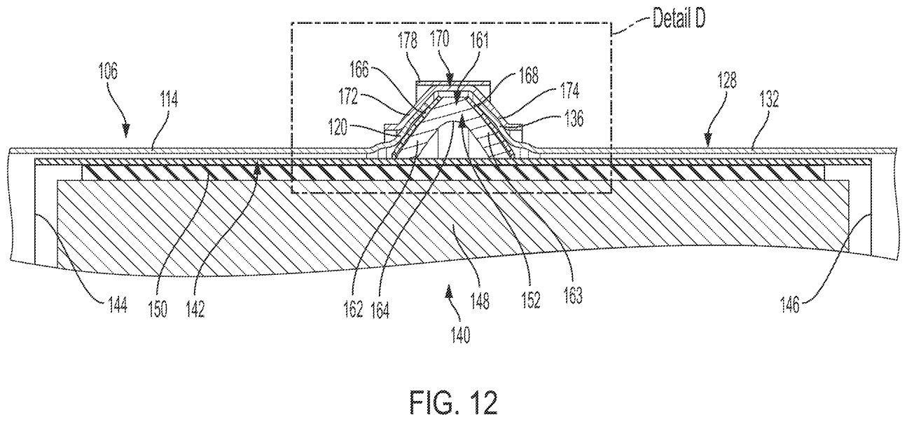

Referring to FIGS. 12-14, in other embodiments, the adaptor 152 comprises the first coupling wall portion 162 coupled to the inlet portion 144 of the aftertreatment component housing 142 and disposed between the inlet coupling flange portion 120 and the aftertreatment component housing 142. The adaptor 152 also comprises the second coupling wall portion 163 coupled to the outlet portion 146 of the aftertreatment component housing 142 and disposed between the outlet coupling flange portion 136 and the aftertreatment component housing 142. The coupler portion 161 is contiguous with the first coupling wall portion 162 and the second coupling wall portion 163 and extends between the inlet coupling flange portion 120 and the outlet coupling flange portion 136. The coupler portion 161 comprises a radial wall portion 164 that is contiguous with the first coupling wall portion 162 and the second coupling wall portion 163 and separated from the aftertreatment component housing 142.

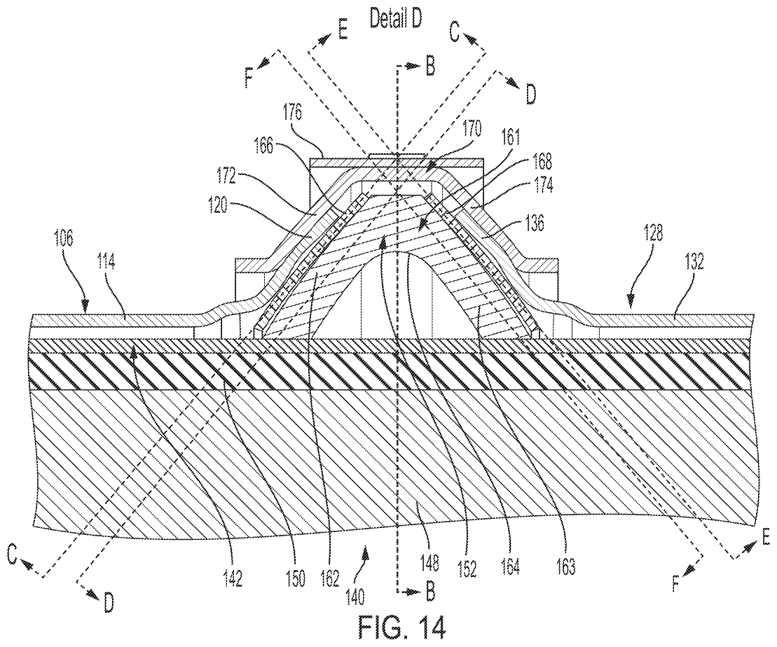

Referring to FIG. 14, in some embodiments, at least a portion of the inlet coupling flange portion 120 is disposed along the inlet coupling flange plane C-C, which is separated from the radial plane B-B by an angle that is approximately equal to between 30 degrees and 60 degrees (e.g., 25 degrees, 30 degrees, 40 degrees, 50 degrees, 60 degrees, 35 degrees, etc.). Similarly, at least a portion of the first coupling wall portion 162 is disposed along the first coupling wall plane D-D which is separated from the radial plane B-B by an angle that is approximately equal to between 30 degrees and 60 degrees (e.g., 25 degrees, 30 degrees, 40 degrees, 50 degrees, 60 degrees, 35 degrees, etc.). In some of these embodiments, the inlet coupling flange plane C-C and the first coupling wall plane D-D are separated from the radial plane B-B by equal angles. Therefore, the first coupling wall portion 162 is parallel with the inlet coupling flange portion 120.

Referring to FIG. 14, in some embodiments, at least a portion of the outlet coupling flange portion 136 is disposed along the outlet coupling flange plane E-E which is separated from the radial plane B-B by an angle that is approximately equal to between 300 degrees and 330 degrees (e.g., 295 degrees, 300 degrees, 315 degrees, 325 degrees, 330 degrees, 335 degrees, etc.). Similarly, at least a portion of the second coupling wall portion 163 is disposed along the second coupling wall plane F-F which is separated from the radial plane B-B by an angle that is approximately equal to between 300 degrees and 330 degrees (e.g., 295 degrees, 300 degrees, 315 degrees, 325 degrees, 330 degrees, 335 degrees, etc.). In these embodiments, the outlet coupling flange plane E-E and the second coupling wall plane F-F are separated from the radial plane B-B by equal angles. Therefore, the second coupling wall portion 163 is parallel with the outlet coupling flange portion 136.

The adaptor 152 is configured to be coupled to the aftertreatment component housing 142 at various positions. For example, in some embodiments, the aftertreatment component cartridge 140 is centered on the center axis λ, as seen in FIG. 3. The adaptor 152 is centered on the radial plane B-B, which is orthogonal to the center axis λ, intersects the center axis λ, and bisects the aftertreatment component cartridge 140. Further, the aftertreatment component cartridge 140 includes an inlet plane G-G that is parallel to the radial plane B-B. Similarly, the aftertreatment component cartridge 140 also includes an outlet plane H-H that is parallel to the radial plane B-B. Both the inlet plane G-G and the outlet plane H-H extend along portions of the aftertreatment component cartridge 140 such that the aftertreatment component cartridge 140 is disposed between the inlet plane G-G and the outlet plane H-H. The inlet plane G-G is separated from the outlet plane H-H by a first distance L₁ along the center axis λ. The radial plane B-B is separated from the inlet plane G-G by a second distance L₂ along the center axis A. In various embodiments, the second distance L₂ is approximately equal to between 40 percent of the first distance L₁ and 60 percent of the first distance L₁ (e.g., 35 percent, 40 percent, 45 percent, 55 percent, 60 percent, 65 percent, etc.). In other embodiments, the second distance L2 may approximately equal to between 60 percent of the first distance L₁ and 80 percent of the first distance L₁ (e.g., 55 percent, 60 percent, 65 percent, 75 percent, 80 percent, 85 percent, etc.).

In various embodiments, the adaptor 152 may be configured in other manners than described above. For example, the adaptor 152 may be coupled to the aftertreatment component housing 142 at a location of a center of mass of the aftertreatment component cartridge 140. In another example with more than one aftertreatment system component 148, the adaptor 152 may be coupled to the aftertreatment component housing 142 at a midpoint between an outlet of one aftertreatment system component 148 and an inlet of another aftertreatment system component 148.

In some embodiments, the fastener is a clamp 170 (e.g., strap, band clamp, etc.), which applies the compressive force to secure the aftertreatment component cartridge 140 to the inlet body 106 and the outlet body 128 and suspends the aftertreatment component cartridge 140 in the aftertreatment system 100, as seen in FIGS. 3, 8, and 14. The clamp 170 includes a first clamp flange portion 172. The first clamp flange portion 172 compresses the inlet coupling flange portion 120 towards the first coupling wall portion 162. In this way, the clamp 170 couples the aftertreatment component cartridge 140 to the inlet body 106. The clamp 170 may include a bolt and a nut which cooperate to facilitate tightening and loosening of the clamp 170.

The clamp 170 also includes a second clamp flange portion 174. The second clamp flange portion 174 compresses the outlet coupling flange portion 136 towards the second coupling wall portion 163. In this way, the clamp 170 also couples the aftertreatment component cartridge 140 to the outlet body 128.

In some embodiments, the clamp 170 includes a band 176 (e.g., ring, belt, etc.). The band 176 is disposed on the outer surface of the clamp 170, as seen in FIG. 3. The clamp 170 also includes a winch 178 (e.g., adjustor, etc.). The winch 178 is used to couple the band 176 to the clamp 170. Therefore, the clamp 170 facilitates suspension of the aftertreatment component cartridge 140 within the inlet body 106 and the outlet body 128. By suspending the aftertreatment component cartridge 140 within the inlet body 106 and the outlet body 128 with the clamp 170, the aftertreatment system component 148 is more easily installed and uninstalled (e.g., for replacement, for servicing, etc.) compared to aftertreatment systems with multiple clamps that must each be removed to access an aftertreatment component. Unlike aftertreatment systems utilizing multiple clamps to suspend the aftertreatment component, use of the clamp 170 also provides additional mounting space on an exterior of the aftertreatment system 100, which provides a greater overall insulation length and reduces the number of joints and openings from which exhaust gas may escape.

In other embodiments, the fastener is a compression joint 180 (e.g., bolted joint, etc.). The compression joint 180 applies a compressive force to secure the aftertreatment component cartridge 140 to the inlet body 106 and outlet body 128 and suspend the aftertreatment component cartridge 140 within the inlet body 106 and the outlet body 128, as seen in FIG. 11. The compression joint 180 also includes a joint fastener 182 (e.g., bolt, screw, threaded fastener, etc.). The joint fastener 182 facilitates attachment of the compression joint 180 and compression of the coupler portion 161 between the inlet coupling flange portion 120 and the outlet coupling flange portion 136. In some embodiments, the inlet coupling flange portion 120, the coupler portion 161, and the outlet coupling flange portion 136 are threaded and are threadably engaged with the compression joint 180.

### III. Example Method of Installing the Aftertreatment Component Cartridge

FIG. 15 illustrates an installation process 1500 (e.g., method, etc.) for installing an aftertreatment component cartridge 140 of the aftertreatment system 100. The installation process 1500 may be performed by, including but not limited to, the original equipment manufacturer (i.e., when the aftertreatment system 100 is assembled, etc.) or a service technician (e.g., a mechanic, line worker, robot, automated machine, etc.).

In various embodiments, the installation process 1500 begins in block 1502 with inserting, by the service technician, the first gasket 166 between the first coupling wall portion 162 and the inlet coupling flange portion 120. In various embodiments, the installation process 1500 continues in block 1504 with inserting, by the service technician, the second gasket 168 between the second coupling wall portion 163 and the outlet coupling flange portion 136. In other embodiments, the first gasket 166 and/or the second gasket 168 is not included.

The installation process 1500 continues in block 1506 with inserting, by the service technician, an inlet portion 144 of the aftertreatment component housing 142 into the inlet body 106. As a result, the first flange portion 154 is disposed between the aftertreatment component housing 142 and the inlet body wall portion 114.

The installation process 1500 continues in block 1508 with inserting, by the service technician, the outlet portion 146 of the aftertreatment component housing 142 into the outlet body 128. As a result, the second flange portion 156 is disposed between the aftertreatment component housing 142 and the outlet body wall portion 132.

The installation process 1500 continues in block 1510 with bringing, by the service technician, the first coupling wall portion 162 into confronting relation with the inlet coupling flange portion 120. The installation process 1500 continues in block 1512 with bringing, by the service technician, the second coupling wall portion 163 into confronting relation with the outlet coupling flange portion 136.

The installation process 1500 continues in block 1514 with placing, by the service technician, a clamp 170 (e.g., strap, band clamp, etc.) over the inlet coupling flange portion 120 and the outlet coupling flange portion 136. As a result, the inlet coupling flange portion 120 and first gasket 166 are disposed between the first clamp flange portion 172 and the first coupling wall portion 162. Additionally, the outlet coupling flange portion 136 and the second gasket 168 are disposed between the second clamp flange portion 174 and the second coupling wall portion 163.

The installation process 1500 continues in block 1516 with tightening, by the service technician, the clamp 170 (e.g., by tightening a nut of the clamp 170, by tightening a bolt of the clamp 170, etc.). As a result, the first clamp flange portion 172 compresses the inlet coupling flange portion 120 such that the first gasket 166 is compressed between the first coupling wall portion 162 and the inlet coupling flange portion 120. Additionally, the second clamp flange portion 174 compresses the outlet coupling flange portion 136 such that the second gasket 168 is compressed between the second coupling wall portion 163 and the outlet coupling flange portion 136.

In some embodiments, the installation process 1500 may be performed without inserting the first gasket 166 and/or the second gasket 168 as described in blocks 1502 and 1504. In these embodiments, the installation process 1500 begins in block 1506 (e.g., skipping blocks 1502 and 1504).

### IV. Example Method of Replacing the Aftertreatment Component Cartridge

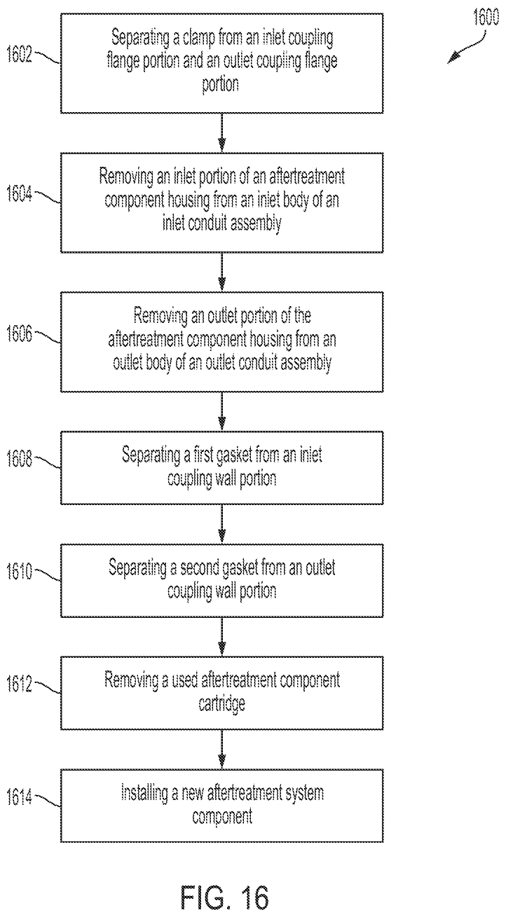

FIG. 16 illustrates a replacement process 1600 (e.g., method, etc.) for replacing an aftertreatment component cartridge 140 of the aftertreatment system 100 that has already been installed (e.g., through the installation process 1500, etc.). The replacement process 1600 may be performed by a service technician.

The replacement process 1600 begins in block 1602 with separating, by a service technician, a clamp 170 from the inlet coupling flange portion 120 and the outlet coupling flange portion 136. Specifically, the first clamp flange portion 172 is separated from the inlet coupling flange portion 120 and the second clamp flange portion 174 is separated from the outlet coupling flange portion 136.

The replacement process 1600 continues in block 1604 with removing, by the service technician, the inlet portion 144 from the inlet body 106. The replacement process 1600 continues in block 1606 with removing, by the service technician, the outlet portion 146 from the outlet body 128.

In some embodiments, the replacement process 1600 continues in block 1608 with separating, by the service technician, the first gasket 166 from the first coupling wall portion 162. In such embodiments, the first gasket 166 may be re-used with a replacement aftertreatment component cartridge 140. Similarly, in some embodiments, the replacement process 1600 continues in block 1610 with separating, by the service technician, the second gasket 168 from the second coupling wall portion 163. In such embodiments, the second gasket 168 may be re-used with a replacement aftertreatment component cartridge 140.

The replacement process 1600 continues in block 1612 with removing, by the service technician, a used aftertreatment component cartridge 140. The replacement process 1600 may be completed in block 1614 by installing, by the service technician, a new aftertreatment component cartridge 140. This installation may be completed according to the installation process 1500, as illustrated in FIG. 15.

In some embodiments, the replacement process 1600 may be performed without performing blocks 1608 and/or 1610, such as when the aftertreatment component cartridge 140 is installed without the first gasket 166 and/or the second gasket 168. In such applications, after removing the inlet portion 144 from the inlet body 106 in block 1604 and removing the outlet portion 146 from the outlet body 128 in block 1606, the replacement process 1600 continues in block 1612 with removing, by the service technician, a used aftertreatment component cartridge 140.

### V. Configuration of Example Embodiments

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W1 to W2, etc.) herein are inclusive of their maximum values and minimum values (e.g., W1 to W2 includes W1 and includes W2, etc.), unless otherwise indicated. Furthermore, a range of values (e.g., W1 to W2, etc.) does not necessarily require the inclusion of intermediate values within the range of values (e.g., W1 to W2 can include only W1 and W2, etc.), unless otherwise indicated.

1. An aftertreatment system comprising:
an inlet conduit assembly comprising an inlet body, the inlet body comprising an inlet body wall portion and an inlet coupling flange portion that is flared outwardly from the inlet body wall portion;
an outlet conduit assembly that is downstream of the inlet conduit assembly and comprises an outlet body, the outlet body comprising an outlet body wall portion and an outlet coupling flange portion that is flared outwardly from the outlet body wall portion;
an aftertreatment component cartridge comprising:
an aftertreatment component housing comprising:
an inlet portion inserted in the inlet body,
an outlet portion inserted in the outlet body;
an adaptor comprising:
a first flange portion having an inner surface coupled to an outer surface of the aftertreatment component housing and disposed between the inlet body wall portion and the aftertreatment component housing,
a second flange portion having an inner surface coupled to the outer surface of the aftertreatment component housing and disposed between the outlet body wall portion and the aftertreatment component housing,
a coupler portion disposed between the first flange portion and the second flange portion, the coupler portion extending between the inlet coupling flange portion and the outlet coupling flange portion; and
an aftertreatment system component positioned within the aftertreatment component housing.

2. The aftertreatment system of claim 1, wherein:
the coupler portion comprises:
a first coupling wall portion contiguous with the first flange portion and extending from the aftertreatment component housing,
a second coupling wall portion contiguous with the second flange portion and extending from the aftertreatment component housing, and
a radial wall portion contiguous with the first coupling wall portion and the second coupling wall portion, the radial wall portion separated from the aftertreatment component housing.

3. The aftertreatment system of claim 2, wherein:
the aftertreatment system is centered on a center axis;
the aftertreatment component cartridge is bisected by a radial plane that intersects the center axis and is orthogonal to the center axis;
at least a portion of the inlet coupling flange portion is disposed along an inlet coupling flange plane which is separated from the radial plane by an angle that is equal to between 10 degrees and 30 degrees; and
at least a portion of the first coupling wall portion is disposed along a first coupling wall plane which is separated from the radial plane by an angle that is equal to between 10 degrees and 30 degrees.

4. The aftertreatment system of claim 3, wherein:
at least a portion of the outlet coupling flange portion is disposed along an outlet coupling flange plane which is separated from the radial plane by an angle that is equal to between 280 degrees and 300 degrees; and
at least at least a portion of the second coupling wall portion is disposed along a second coupling wall plane which is separated from the radial plane by an angle that is equal to between 280 degrees and 300 degrees.

5. The aftertreatment system of claim 4, further comprising:
a clamp to secure the aftertreatment component cartridge to the inlet body and to secure the aftertreatment component cartridge to the outlet body, the clamp comprising:
a first clamp flange portion that compresses the inlet coupling flange portion towards the first coupling wall portion, and
a second clamp flange portion that compresses the outlet coupling flange portion towards the second coupling wall portion.

6. The aftertreatment system of claim 5, further comprising a first gasket disposed between the inlet coupling flange portion and the first coupling wall portion and separated from the aftertreatment component housing by the adaptor.

7. The aftertreatment system of claim 6, further comprising a second gasket disposed between the outlet coupling flange portion and the second coupling wall portion and separated from the aftertreatment component housing by the adaptor.

8. The aftertreatment system of claim 4, wherein:
the inlet body further comprises an inlet curved portion contiguous with the inlet body wall portion and the inlet coupling flange portion, at least a portion of the inlet curved portion extending along a first slope from the inlet body wall portion; and
the outlet body further comprises an outlet curved portion contiguous with the outlet body wall portion and the outlet coupling flange portion, at least a portion of the outlet curved portion extending along a second slope from the outlet body wall portion.

9. The aftertreatment system of claim 1, wherein:
the aftertreatment component cartridge is centered on a center axis;
the adaptor is centered on a radial plane, the radial plane being orthogonal to the center axis, intersecting the center axis, and bisecting the aftertreatment component cartridge;
the aftertreatment component cartridge is disposed between an inlet plane and an outlet plane, the inlet plane being parallel to the radial plane and extending along a portion of the aftertreatment component cartridge, the outlet plane being parallel to the radial plane and extending along a portion of the aftertreatment component cartridge, the inlet plane being separated from the outlet plane by a first distance along the center axis; and
the radial plane is separated from the inlet plane by a second distance along the center axis, the second distance being equal to between 40 percent of the first distance and 60 percent of the first distance.

10. An aftertreatment system comprising:
an inlet conduit assembly comprising an inlet body that receives an exhaust gas, the inlet body comprising an inlet body wall portion and an inlet coupling flange portion that is flared outwardly from the inlet body wall portion;
an outlet conduit assembly that is downstream of the inlet conduit assembly and comprises an outlet body, the outlet body comprising an outlet body wall portion and an outlet coupling flange portion that is flared outwardly from the outlet body wall portion;
an aftertreatment component cartridge comprising:
an aftertreatment component housing comprising:
an inlet portion inserted in the inlet body,
an outlet portion inserted in the outlet body;
an adaptor comprising:
a first coupling wall portion having an inner surface coupled to an outer surface of the aftertreatment component housing and disposed between the inlet coupling flange portion and the aftertreatment component housing,
a second coupling wall portion having an inner surface coupled to the outer surface of the aftertreatment component housing and disposed between the outlet coupling flange portion and the aftertreatment component housing,
a coupler portion contiguous with the first coupling wall portion and the second coupling wall portion, the coupler portion extending between the inlet coupling flange portion and the outlet coupling flange portion; and
an aftertreatment system component positioned within the aftertreatment component housing.

11. The aftertreatment system of claim 10, the coupler portion comprising a radial wall portion contiguous with the first coupling wall portion and the second coupling wall portion, the radial wall portion separated from the aftertreatment component housing.

12. The aftertreatment system of claim 11, wherein:
the aftertreatment component cartridge is centered on a center axis;
the aftertreatment component cartridge is bisected by a radial plane that intersects the center axis and is orthogonal to the center axis;
at least a portion of the inlet coupling flange portion is disposed along an inlet coupling flange plane which is separated from the radial plane by an angle that is equal to between 30 degrees and 60 degrees; and
at least a portion of the first coupling wall portion is disposed along a first coupling wall plane which is separated from the radial plane by an angle that is equal to between 30 degrees and 60 degrees.

13. The aftertreatment system of claim 12, wherein:
at least a portion of the outlet coupling flange portion is disposed along an outlet coupling flange plane which is separated from the radial plane by an angle that is equal to between 300 degrees and 330 degrees; and
at least a portion of the second coupling wall portion is disposed along a second coupling wall plane which is separated from the radial plane by an angle that is equal to between 300 degrees and 330 degrees.

14. An aftertreatment component cartridge for an aftertreatment system, the aftertreatment component cartridge comprising:
an aftertreatment component housing;
an adaptor comprising:
a first flange portion having an inner surface coupled to an outer surface of the aftertreatment component housing,
a first connecting wall portion contiguous with the first flange portion, a portion of the first connecting wall portion extending along a first slope from the first flange portion, the first slope having a first angle along a reference plane bisecting the adaptor,
a first coupling wall portion contiguous with the first connecting wall portion, a portion of the first coupling wall portion extending along a second slope from the first connecting wall portion, the second slope having a second angle along the reference plane, the second angle greater than the first angle,
a second flange portion having an inner surface coupled to the outer surface of the aftertreatment component housing,
a second connecting wall portion contiguous with the second flange portion, a portion of the second connecting wall portion extending along a third slope from the second flange portion, the third slope having a third angle along the reference plane,
a second coupling wall portion contiguous with the second connecting wall portion, a portion of the second coupling wall portion extending along a fourth slope from the second connecting wall portion, the fourth slope having a fourth angle along the reference plane, the fourth angle less than the third angle, and
a coupler portion contiguous with the first coupling wall portion and the second coupling wall portion; and
an aftertreatment system component positioned within the aftertreatment component housing.

15. The aftertreatment component cartridge of claim 14, wherein:
the aftertreatment component cartridge is centered on a center axis;
the aftertreatment component cartridge is bisected by a radial plane that intersects the center axis and is orthogonal to the center axis; and
at least a portion of the first coupling wall portion is disposed along a first coupling wall plane which is separated from the radial plane by a fifth angle that is equal to between 10 degrees and 30 degrees.

16. The aftertreatment component cartridge of claim 15, wherein at least at least a portion of the second coupling wall portion is disposed along a second coupling wall plane which is separated from the radial plane by a sixth angle that is equal to between 280 degrees and 300 degrees.

17. The aftertreatment component cartridge of claim 14, wherein:
the aftertreatment component cartridge is centered on a center axis;
the first connecting wall portion further comprises a first flat portion contiguous with the first connecting wall portion, the first flat portion extending parallel to the center axis; and
the second connecting wall portion further comprises a second flat portion contiguous with the second connecting wall portion, the second flat portion extending parallel to the center axis.

18. The aftertreatment component cartridge of claim 14, wherein:
the aftertreatment component housing is centered on a center axis;
the adaptor is centered on a radial plane, the radial plane being orthogonal to the center axis, intersecting the center axis, and bisecting the aftertreatment component housing;
the aftertreatment component housing is disposed between an inlet plane and an outlet plane, the inlet plane being parallel to the radial plane and extending along a portion of the aftertreatment component housing, the outlet plane being parallel to the radial plane and extending along a portion of the aftertreatment component housing, the inlet plane being separated from the outlet plane by a first distance along the center axis; and
the radial plane is separated from the inlet plane by a second distance along the center axis, the second distance being equal to between 40 percent of the first distance and 60 percent of the first distance.

19. A method for installing an aftertreatment component cartridge in an aftertreatment system having an inlet conduit assembly, an outlet conduit assembly, and a clamp, the inlet conduit assembly including an inlet body with an inlet body wall portion and an inlet coupling flange portion, the outlet conduit assembly including an outlet body with an outlet body wall portion and an outlet coupling flange portion, the aftertreatment component cartridge including an aftertreatment component housing with an inlet portion and an outlet portion, and an adaptor with a first flange portion coupled to the aftertreatment component housing, a second flange portion coupled to the aftertreatment component housing, a first coupling wall portion contiguous with the first flange portion and having a portion that extends along a first slope from the first flange portion, and a second coupling wall portion contiguous with the second flange portion and having a portion that extends along a second slope from the second flange portion, and the clamp including a first clamp flange portion and a second clamp flange portion, the method comprising:
inserting the inlet portion into the inlet body such that the first flange portion is disposed between the aftertreatment component housing and the inlet body wall portion;
inserting the outlet portion into the outlet body such that the second flange portion is disposed between the aftertreatment component housing and the outlet body wall portion;
bringing into confronting relation, after inserting the inlet portion into the inlet body and the outlet portion into the outlet body, the first coupling wall portion and the inlet coupling flange portion; and
bringing into confronting relation, after inserting the inlet portion into the inlet body and the outlet portion into the outlet body, the second coupling wall portion and the outlet coupling flange portion.

20. The method of claim 19, further comprising inserting a first gasket between the first coupling wall portion and the inlet coupling flange portion.

21. The method of claim 20, further comprising inserting a second gasket between the second coupling wall portion and the outlet coupling flange portion.

22. The method of claim 20, further comprising compressing, after inserting the first gasket between the first coupling wall portion and the inlet coupling flange portion, the first gasket between the first coupling wall portion and the inlet coupling flange portion.

23. The method of claim 22, further comprising:
inserting a second gasket between the second coupling wall portion and the outlet coupling flange portion; and
compressing, after inserting the second gasket between the second coupling wall portion and the outlet coupling flange portion, the second gasket between the second coupling wall portion and the outlet coupling flange portion.

24. The method of claim 19, further comprising placing, after bringing into confronting relation the first coupling wall portion and the inlet coupling flange portion and bringing into confronting relation the second coupling wall portion and the outlet coupling flange portion, the clamp over the inlet coupling flange portion and the outlet coupling flange portion such that the inlet coupling flange portion is disposed between the first clamp flange portion and the first coupling wall portion and the outlet coupling flange portion is disposed between the second clamp flange portion and the second coupling wall portion.

25. The method of claim 19, further comprising:
separating, prior to inserting the inlet portion into the inlet body or inserting the outlet portion into the outlet body, the first coupling wall portion and the inlet coupling flange portion;
separating, prior to inserting the inlet portion into the inlet body or inserting the outlet portion into the outlet body, the second coupling wall portion and the outlet coupling flange portion;
removing, prior to inserting the inlet portion into the inlet body or inserting the outlet portion into the outlet body, the inlet portion from the inlet body;
removing, prior to inserting the inlet portion into the inlet body or inserting the outlet portion into the outlet body, the outlet portion from the outlet body; and
removing, prior to inserting the inlet portion into the inlet body or inserting the outlet portion into the outlet body, a used aftertreatment component cartridge.
